(19) United States
(12) Patent Application Publication
(10) Pub. No.: US 2003/0212639 A1
(43) Pub. Date: Nov. 13, 2003

(54) Method and system for providing secure authoring services for protected software

(76) Inventors: Paul A. Cronce, San Jose, CA (US); Richard Hoiberg, Gilroy, CA (US); Joseph M. Fontana, San Jose, CA (US)

Correspondence Address: SAWYER LAW GROUP LLP, P O BOX 51418, PALO ALTO, CA, 94303, US

(21) Appl. No.: 10/140,913

(22) Filed: May 6, 2002

(51) Int. Cl. G06F 17/60

(52) U.S. Cl. 705/57

(57) ABSTRACT

A method and system for providing a secure authoring service for protected software is disclosed. The method and system include creating a protection authoring toolset on a networked server, and receiving a copy of the software product to be protected from a software publisher over a network. The method and system further include processing the software product on the server using the protection authoring toolset, such that the software product is wrapped with a protection wrapper, and returning the protected software product to the publisher over the network for testing and delivery to customers.

### FIELD OF THE INVENTION

The present invention relates to anti-piracy protection for computer software, and more particularly to providing secure authoring services to protect software from hackers.

### BACKGROUND OF THE INVENTION

Software licensing and anti-piracy protection has been used for some time in the software industry as a means of controlling use of software, and more particularly, for the purpose of limiting or eliminating unauthorized use of software, known as software piracy.

The resulting economic dislocation that occurs due to software piracy is severe. As the cost of developing and supporting software programs increases, the need to reduce piracy grows. One of the key elements of reducing software piracy is through the use of an electronic software license, delivered to the authorized user to enable the software program to operate. The electronic license includes the required information in a form that is understood by the software program, and contains license terms.

License terms are the terms that apply to the use of the particular copy of the software program, and can include a start date, an end date, a number of program launches, fingerprint information to limit use on a specific local area network or on a specific machine, and other controlling information. For increased security, the electronic software license may be encrypted to hamper hacker efforts to bypass its function. This requires that the software program contain a decryption key to decrypt the license before extracting the information required.

In addition to license files, other anti-piracy tools have been employed. These tools typically are used to add various types of authentication to the program being protected, such as decryption, checksum validation, and overriding various debug mechanisms in the operating system and hardware. All of these and other techniques were created for the purpose of making it difficult for a software hacker to break into the application code and remove it from its protection “wrapper” so it can be provided free of any license terms at no cost or very low cost, and where the software publisher receives no payment of any kind for its use. The process of adding protection software to a software application is often referred to as “wrapping.” Wrapping tools are typically sold to software developers who then perform the wrapping process on each software program prior to shipping the software to customers.

Since the runtime environment for the software program and its protection wrapper is typically unprotected, such as with Microsoft Corporation's Windows Operating System, and since a large number of programmers have extensive knowledge of programming on such a system, it is difficult to effectively protect software running on such machines. In addition to having extensive knowledge of the operating environment, hackers also can purchase or “borrow” a copy of the protection-wrapping tool. By studying the operation of the tool, the hacker gains a much deeper understanding of the protection mechanisms and techniques used by the tool than by studying only the resulting protected software, resulting in much less work to compromise a given protected software product. In fact, the level of difficulty for breaking protected code without this additional aid is sufficiently high that most hackers will take great pains to acquire a copy of the protection tool for the purpose of studying its operation. Thus, it is extremely important to protect the wrapping tool itself. Otherwise, if the tool finds its way into the wrong hands, the security of every program wrapped for protection by the tool is at a substantially higher risk of being compromised.

Accordingly, what is needed is a method and system for delivering protection and licensing tools such that their operation cannot be studied. This will in effect greatly enhance the security of all software programs protected by the tools. The present invention addresses such a need.

### SUMMARY OF THE INVENTION

The present invention provides a method and system for providing a secure authoring service for protected software. The method and system include creating a protection authoring toolset on a networked server, and receiving a copy of the software product to be protected from a software publisher over a network. The method and system further include processing the software product on the server using the protection authoring toolset, such that the software product is wrapped with a protection wrapper, and returning the protected software product to the publisher over the network for testing and delivery to customers.

According to the system and method disclosed herein, by providing a web-enabled authoring toolset, the present invention removes the protection tool from the public, and therefore from inspection and study by hackers, thereby greatly increasing the security of the final protected software product. Also, by centralizing the toolset and the public/private key generation process and storage, the possibility of stolen keys is dramatically reduced, and therefore the licensing process is more secure.

### BRIEF DESCRIPTION OF THE DRAWINGS

FIG. 1 is a flow diagram of a conventional method for providing authoring and licensing services for protected software.

FIG. 2 is a flow diagram for providing secure authoring services for protected software according to the present invention.

FIG. 3 is a flow diagram for providing secure authoring and licensing services for protected software according to the present invention.

FIG. 4 is a block diagram of a secure software authoring system in a preferred embodiment of the present invention.

FIG. 5 is a block diagram of a second embodiment of a secure software authoring system.

FIG. 6 is a block diagram of one embodiment of a secure software authoring system having remote protected functions.

FIG. 7 is a block diagram of one embodiment of the protected software after wrapping is complete.

### DETAILED DESCRIPTION

The present invention relates to a method and system providing a secure authoring service for protected software. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

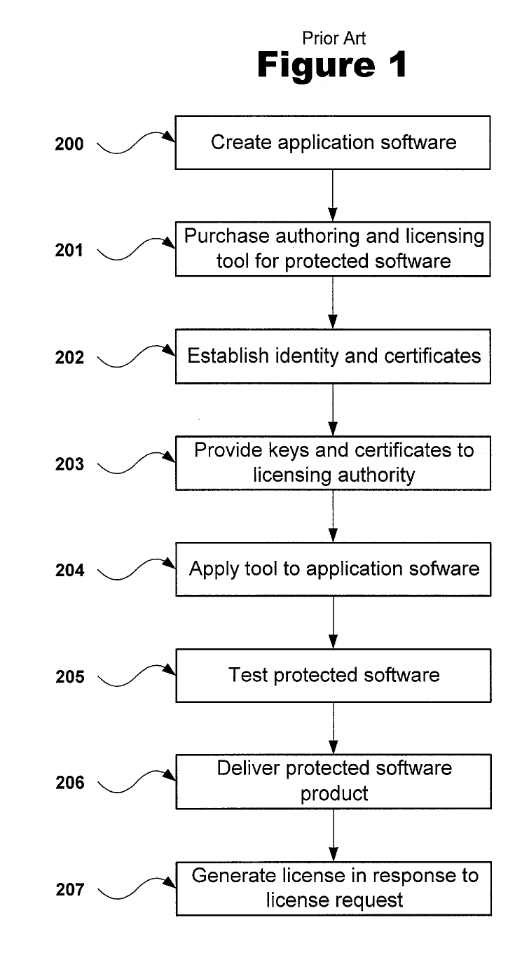

Referring to FIG. 1, a flow diagram of a conventional method for providing authoring and licensing services for protected software is shown. In step 200, the publisher creates the application program to be protected and licensed. In step 201, the software publisher purchases a protection- and licensing-authoring toolset from a toolset provider and installs it on a local computer. In step 202, prior to using the toolset, the identity of the publisher is established using a standard certificate and public/private key generation and authentication process. This step is important because it ties into the creation of license requests and license generation. The identity-checking step may also be a prerequisite for the purchasing step. This process of requesting and generating licenses with certificates is described in detail in U.S. patent application Ser. No. 10/072,597 entitled “A METHOD AND SYSTEM FOR DELIVERY OF SECURE SOFTWARE LICENSE INFORMATION,” and will not be described in detail herein.

In step 203, the certificates and private keys are provided to the licensing authority for the purpose of generating licenses for the application program. One of the security problems arises here, where there are multiple copies of the private keys—one set with the publisher, and one with the licensing authority. Of course the publisher may provide both services. However, managing private keys effectively and securely is non-trivial, especially when large organizations are involved. It is possible, for example, for a disgruntled employee to gain access to the private keys, and transfer them to an outside party. This action would severely compromise the security of the protected software product.

At this point, depending on the requirements of the toolset, the publisher may make changes to the application program source code for the purpose of preparing it for operation with the protection wrapper that will be placed around the application program by the toolset. These changes may include inserting data structures and code at various points within the application program. In some cases, some information may be required by the toolset to properly process the application program. This information may be provided by the software publisher manually, or automatically by the development tools used to create the executable application code for protection-authoring toolset processing. The requirements for additions and changes to the application program for the purpose of enabling various protection mechanisms would be provided to the publisher by the toolset provider, and will be dependent on the functions provided by the protection-authoring toolset. These instructions provided with the toolset, if made available to a hacker, will greatly assist his efforts to hack the protection wrapper.

In step 204, the publisher executes the protection-authoring toolset on the local computer to process and wrap the application program executable code. This may include specifying a number of parameters and options by the publisher. The output of this step is a protection-wrapped application program, using whatever mechanisms and techniques provided by the toolset and selected by the publisher for anti-piracy protection. In addition, a license authentication program is optionally included within the protection wrapper to generate license requests, receive licenses, and authenticate licenses.

In step 205, the publisher tests the protection-wrapped application. Upon successful testing, the application is delivered as a product to end users in step 206. Finally, in step 207, when the end user runs the application, and it includes the license authorization program that requires a license for use, such as after a demo period has elapsed, the authorization program within the protection wrapper generates a license request. This request is sent to the licensing authority, and an appropriate license is generated and returned to the application program. The authorization program authenticates the license as part of the protection process.

In the process described above, the protection-authoring toolset is purchased by the software publisher for use on his local computer during the application development process. This fact does not in and of itself present a problem in security. However, the toolset is available to a number of programmers, and working copies can be transferred to friends and acquaintances without detection. If one of these friends or acquaintances happens to be a software hacker, or passes the toolset on to a hacker, the security of the protected application can be seriously compromised as described above. The protection mechanisms are much easier to pinpoint and study when they are being applied to an unprotected software application than when acting as designed as part of a protected software application. Alternatively, the protection-authoring software can be purchased by an individual masquerading as a software publisher, and thus fall directly into the hands of a hacker.

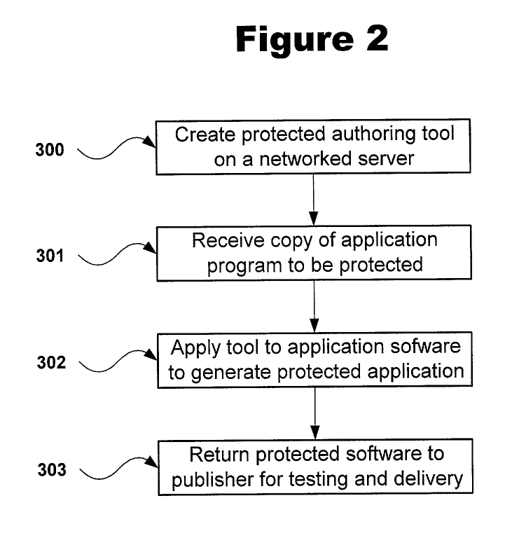

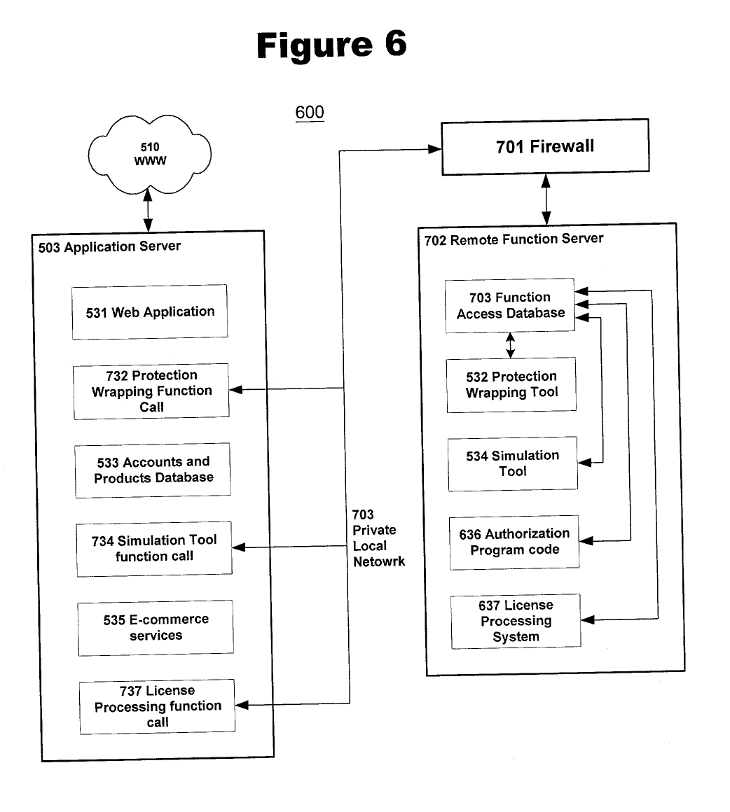

Referring to FIG. 2, a flow diagram for providing secure authoring services for protected software according to the present invention is shown. In step 300, the protection-authoring toolset is created to run on a networked server. In the preferred embodiment, this toolset is placed on a separate server behind a firewall, and only accessible as a processing function, as described below in relation to FIG. 6. In effect, it becomes a “black box” with inputs of options, preferences, and an executable program file, and an output of a protected program file. This extra level of protection prevents the toolset from being downloaded by a hacker from the server. At best, a hacker might get a program wrapped for free by the toolset if the server was successfully hacked, but the hacker would not be able to study the process of wrapping taking place behind the firewall.

In step 301, a copy of the application program to be protected is received from the publisher at the server. In the preferred embodiment, the application program is transmitted securely using SSL (Secure Socket Layer) to prevent the application program from being stolen during the transfer. SSL is known to one of ordinary skill in the art, and will not be described in detail herein.

In step 302, the server sends the received application code to the protection-authoring toolset for processing, along with any specified options and preferences indicated by the publisher. The toolset processes the application executable into a protection-wrapped application. In step 303, the protection-wrapped application is returned to the publisher over the network for testing and delivery. This transfer is also protected using SSL in the preferred embodiment.

One major advantage of the approach described above in relation to FIG. 2 is the reduction in effort to support multiple computing platforms by the tool provider. Specifically, the tools only need to run in a single server environment, and do not need to be created for various versions of the Windows and Macintosh operating systems and various flavors of Unix that are currently in use. However, the function of the wrapping tool must be modified depending on the target system, and any code generated, such as the wrapper code itself, must be generated in a compatible format for the target system. Even with this requirement, having the toolset run in a single environment is a major reduction in testing and programming effort. Additionally, when an improvement is made, or a new release with new functions is created on the server, the new versions are immediately available for all licensed users. Therefore, there are no distribution costs or delay associated with bug fixes and improvements. Of course new features can also be withheld from users, and only released for their use when an upgrade service fee is paid.

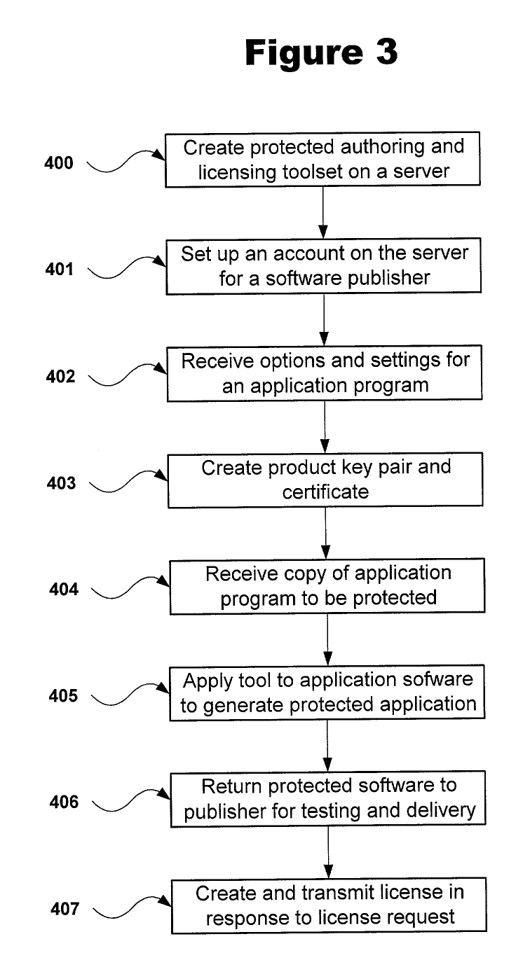

Referring to FIG. 3, a flow diagram for providing secure authoring and licensing services for protected software according to the present invention is shown. This process is similar to the process described above in relation to FIG. 2, with the addition of providing license generation for the application software. In step 400, the protection-authoring and licensing toolset is created to run on a networked server, as described previously. In the preferred embodiment, the license-processing component of the toolset requires the use of public/private key pairs and certificates. In order to protect the private keys from hackers, they cannot be stored directly on the server. In the preferred embodiment, the keys and algorithms for decrypting and encrypting required for license request validation and license generation are stored in a separate, removable device, accessible only as an encryption and decryption service. Thus, a successful hacker will not be able to access the keys themselves, but at most request and receive encryption or decryption services.

In step 401, an account for the publisher is created on the server. This step typically includes identity verification, such as receiving a certificate from the publisher along with the private key, or by generating the key pair and requesting a certificate from a certificate authority. In the preferred embodiment, the certificate authority is the toolset provider. In any case, the certificate generation process must include validation of the claimed identity of the publisher. This step is helpful in preventing known or suspected hackers from receiving access to the web application.

In step 402, the publisher prepares to generate protected and licensed copies of an application program by entering options and settings into the web application providing the wrapping services. Additional settings and options may be required for controlling the license generation services, as well. In step 403, assuming this is the first run for a given application program, a product public/private key pair is created, along with a certificate signed by the publisher private key. If this is not the first run, then an already existing key pair and certificate are retrieved from a secure location. This key pair and certificate are used for generating and validating license requests, and is described in detail in U.S. patent application Ser. No. 10/072,597 entitled “A METHOD AND SYSTEM FOR DELIVERY OF SECURE SOFTWARE LICENSE INFORMATION,” and will not be described in more detail herein.

In step 404, a copy of the application program to be protected is received from the publisher at the server. In the preferred embodiment, the application program is transmitted securely using SSL (Secure Socket Layer) to prevent the application program from being stolen during the transfer.

In step 405, the server sends the received application code to the protection-authoring and licensing toolset for processing, along with any specified options and preferences indicated by the publisher. The toolset processes the application executable into a protection-wrapped and license-managed application. In step 406, the protection-wrapped and license-managed application is returned to the publisher over the network for testing and delivery. This transfer is also protected using SSL in the preferred embodiment.

Finally, in step 407, after the wrapped application is delivered to end users and run, licenses are generated and transmitted to the license-managed application in response to validated license requests, using inputs from the user via the authorization program component within the protection wrapper and/or settings at the license server, typically in conjunction with a financial transaction.

The process described in relation to FIG. 3 has the same advantages as described above in relation to FIG. 2. In the preferred embodiment, the wrapping tool itself performs all modifications to the application executable required by the wrapping tool. This eliminates the need to provide instructions to the developer on changes to make to the application code. These instructions could have easily fallen into the hands of a hacker, and provide aid and assistance to his hacking effort.

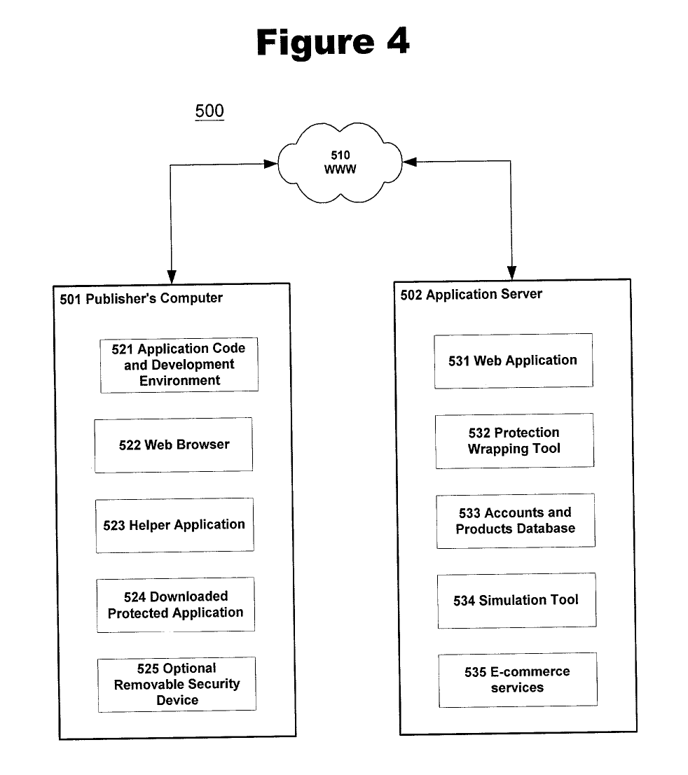

Referring to FIG. 4, a block diagram of a secure software authoring system in a preferred embodiment of the present invention is shown. The system 500 includes a publisher's computer 501 and application server 502 connected to a network 510. In the preferred embodiment, the network 510 is the Internet or World Wide Web, although any type of network may be used. The publisher's computer 501 contains the application code and development environment 521 of the software application for which the publisher wishes to apply the protection wrapping features provided by the application server 502. Also required is a web browser 522 to access and interface with the application server 502 using HTTP (Hypertext Transfer Protocol). HTTP is widely known in the industry as the standard used by web browsers and application servers, and will not be described in detail herein.

An additional application, helper application 523, may be required for some functions. In the preferred embodiment, where license authorization information is stored in an optional removable security device 525, the helper application 523 is required to provide the interface between the functions of the web browser 522 and the security device 525. In operation, the web application provides an authorization to be stored in the removable security device 525. This authorization is then transferred to the security device by helper application 523. The resulting authorization is carried within the removable security device 525, and is accessed by the protection wrapper for license authorization when the application program 524 is launched. The operation of such a security device 525, server 502, and helper application 523 is described in detail in U.S. patent application Ser. No. 10/072,597 entitled “A METHOD AND SYSTEM FOR DELIVERY OF SECURE SOFTWARE LICENSE INFORMATION,” and U.S. patent application Ser. No. 10/080,639 entitled “DELIVERY OF A SECURE SOFTWARE LICENSE FOR A SOFTWARE PRODUCT AND A TOOLSET FOR CREATING THE SOFTWARE PRODUCT,” which is hereby incorporated by reference.

Finally, resident on the publisher's computer 501 is the downloaded protected application 524, after the upload and wrapping process has been completed, and the protected application 524 has been downloaded from application server 502. The publisher can test this protected application 524 on his computer 501. If the tests do not succeed, the application 524 may require changes, and rewrapping. Once the protected application 524 satisfies the publisher, it can be delivered as a protected application product.

Application server 502 contains a web application 531. A web application consists of a set of web pages, either static or dynamic. Dynamic pages are generated by software on the server 502 in response to page requests from the publisher's computer 501, while static pages are delivered from existing files resident on the server 502. Dynamic pages are used when a page contains information retrieved from a database, for example. Dynamic pages would be required in this web application for pages including publisher's account information, status, history, and billing.

In the preferred embodiment, a very important function provided by the web application 531 is a management tool (not shown). This management tool is most useful for large software publishers, by allowing the account administrator to set up various levels of access to the account for different users in the publisher's organization. For example, the software developers may have access to the wrapping settings and options pages, but the software testing organization would not have such access. The billing department may have access to billing pages, but the software developers would not have such access. Downloads of wrapped software applications may only be accessible by the software developers and the testing department. By providing this management tool, complete control of the process of protection wrapping can be achieved, reducing the possibility of unauthorized access to secure functions, and thereby increasing the resulting security of the protected software 524. An additional aspect of the management tool is its billing function. Specifically, charges can be applied to the account for each user set up on the system. Different charges can be applied for different functions. For example, a developer, with access to the wrapping and simulation function may require a higher fee than a tester, who may only need access to information and settings used to create the protected product being tested.

According to another aspect of the present invention, the application server 502 is provided with a protection-wrapping tool 532, which is not made publicly available. For security purposes, this tool may reside on the server 502 only as a remote function call to another more secure server, such as a server behind a firewall, where the only access is a function provided by the remote call. Other methods of protecting the toolset from access by server hackers are well known to one of ordinary skill in the art, and will not be discussed herein. The wrapping tool 532 processes the executable form of the application code 521 into the protected application 524.

User account and product information associated with a given application 524 are stored in a database on the application server 502, or on a remote, secure server (not shown). An associated e-commerce function 535 of the web application 502 may be used for the purpose of billing the publisher for services rendered by the application server 502. Billing can include an account setup fee, a yearly subscription fee, a wrapping fee, a storage fee for history files, user account fees based on type described earlier, and a data transfer fee, for example.

In the preferred embodiment, an important component of the database includes the wrapping history for any given product. This would include the settings and options for each wrap, the version number of the protection wrapper, the version number of the software application 521, and a copy of the resulting wrapped application 524. In addition, a “wrapping number” assigned by the server can be utilized as a unique identifier. This unique identifier (ID) can be provided to the publisher, and embedded in the protection wrapper. If a problem occurs in the field associated with the protection wrapper, the publisher can identify the version using the wrapping ID, and the tool provider can retrieve the specific version of software from the database for immediate testing and evaluation. This feature greatly reduces the effort and time for customer support by the publisher and tool provider. In the preferred embodiment, the publisher would have the ability to indicate which history files represent delivered products, such that only useful history files would be saved, and no longer useful files could be discarded, thus reducing the required history file storage space.

According to another aspect of the present invention, the application server 502 in the preferred embodiment includes a simulation tool 534, which is used to simulate the user interface generated by the protection wrapper. This user interface is used to interact with the user for the selection of license terms, purchasing of licenses or extensions of licenses, or demo periods, for example. This interface usually is presented at application launch, and notifies the user of any temporary conditions, such as “only 10 days left for free demo” as an example. The user can interact with this interface to select which feature set of the application he chooses to purchase, and allows an on-line license purchase, in the preferred embodiment. Most of the interactions presented by the protection wrapper are controlled by settings and preferences, set by the publisher prior to initiating the wrapping process. Other aspects of the interaction presented can be controlled by the licensing terms provided within the license generated by the license server function. In the preferred embodiment, simulator settings or license server settings can be used to control license terms for simulation purposes.

Presenting the user interface of the protection wrapper via web page transactions allows a publisher to easily and quickly test the options and settings set before actual wrapping and download of the protected application 524. This can save repeated downloads of the protected application 524 during the debugging process, and as the publisher refines the options and settings. In addition, the simulation tool 534 is not available for study and analysis by software hackers, and remains on the server 502. In the preferred embodiment, the simulator tool 534 is also protected in an appropriate manner to prevent access by server hackers.

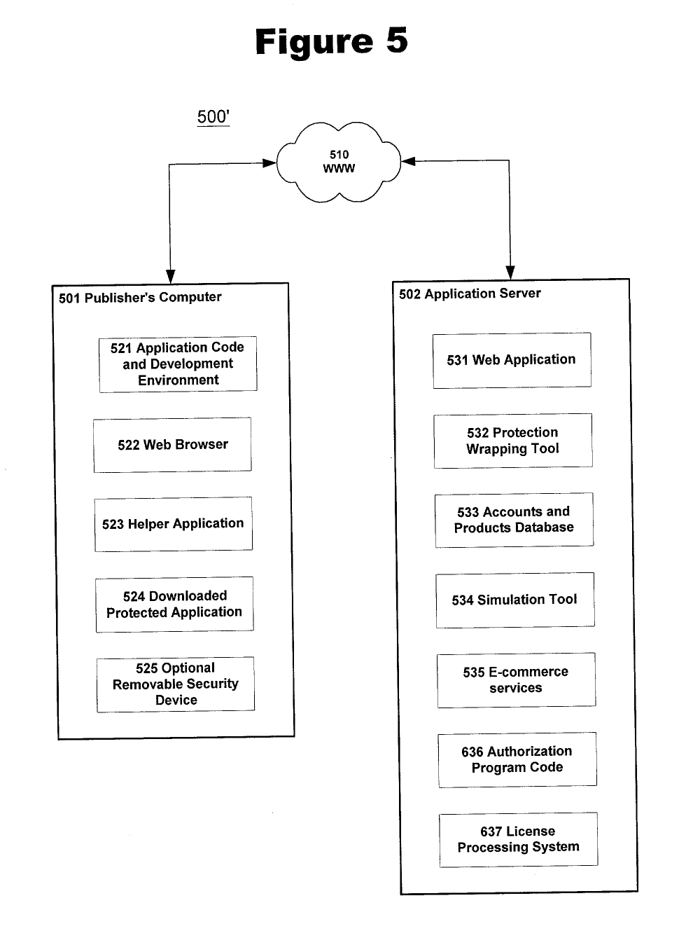

Referring to FIG. 5, a block diagram of a second embodiment of a secure software authoring system. This system 500′ is similar to FIG. 4 described above, with the addition of license authorization code 636 and license processing and generating system 637. License authorization code 636 is combined with the protection wrapper for the purpose of requesting licenses and authorizing the use of the application 524 by validation of a license. The license processing system 637 is used to receive and validate license requests from the license authorization code 636, and to generate appropriate licenses to return to the protected and license-managed application 524. In the preferred embodiment, all private keys are stored within a removable security device (not shown) at the server 502′, such that they are not accessible by hacking the server 502′. In a further embodiment, the application server 502 is provided with remote control and reporting functions (not shown) to allow the delivery of application server as a product to large software publishers or organizations of smaller software publishers. The ability to deliver the server technology as a complete product has many benefits, including allowing the publishers to be self-reliant, and not dependent on other organizations to get products out the door. Using the remote control feature, activity reports can be requested. The tool provider or another selected provider may still maintain some remote functions, such as the wrapping tool 502, on separate servers to maintain security, if desired, as described below. The remote control would also contain the ability to extend or deny licensing and wrapping by way of modifications to licensing and wrapping terms, stored in secure form within the server. Thus, if a server was being used beyond the limits allowed by the term of the agreement of sale, the server could be shut down remotely. Of course if the tool provider maintains remote function servers, access to these functions can be controlled or denied, as necessary, by account or server ID.

Referring to FIG. 6, a block diagram of one embodiment of a secure software authoring system having remote protected functions is shown. The system 600 includes an application server 503 along with a remote function server 702, which is protected by a firewall. The remote function server 702 includes underlying security functions, including the protection wrapping function 532, the simulation tool 534, the authorization program code 636, and the license processing system 637. The remote function server 702 is accessed only be very restricted function calls using encryption technology, such as VPN (virtual private network) tunneling, over a private local network 703. The function of a firewall 701 and VPN is well known to one of ordinary skill in the art, and will not be described in detail herein. The application server 503 in this case is the same as described above in relation to FIGS. 4 and 5, except that the protected functions moved to the remote function server 702 have been replaced with secure function calls 732, 734, and 737. The application server 503 in this embodiment can be sold as a product to large software publishers or groups of publishers, without opening the door to security violations by employees of the publishers. All high-security functions are still maintained by the tool provider or appointed third party, thus reducing the possibility of a hacker getting access to the protection process by way of an employee of the publisher. In this case, the network connecting the application server 503 and remote function server 702 may be either a private network 703 or the same network 510 used between the publisher's computer 501 and the application server 502.

Another embodiment of the remote server 702 includes the storage of the history files for each customer. Specifically, to avoid a double overhead on the network of first uploading the application software to server 503, then transferring it to remote server 702, receiving the wrapped software at server 503 from server 702, and then transferring the wrapped software back to the customer, the remote 101 server 702 should directly receive the software to be wrapped from the publisher. Likewise, the wrapped software history files should remain on remote server 702, and the protection-wrapped software should be returned to the publisher directly from server 702. All of these operations can be performed under the control of server 503, and the complexities of the 3-way communication hidden from the publisher using the tools using conventional server and network technology.

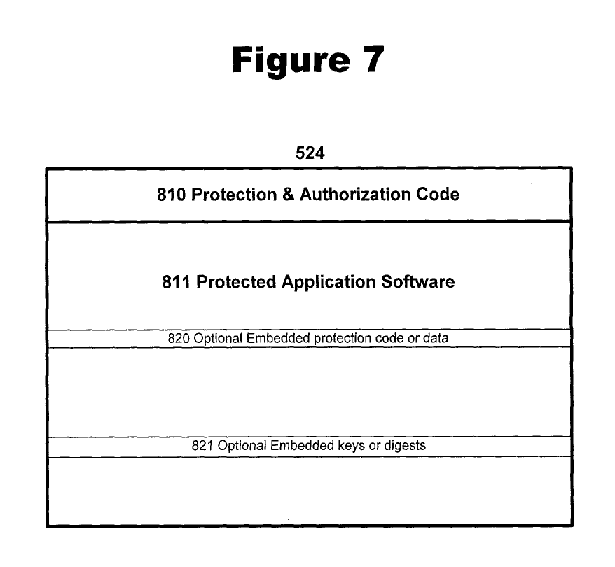

Referring to FIG. 7, a block diagram of one embodiment of the protected software after wrapping is complete is shown. Protected application 524 includes the executable form 811 of the application code 521, along with protection wrapper 810. If license service is included, either from the tool, application server 502 or another server provided by the publisher, license request and authorization code is also included with the protection wrapper. Also, embedded protection code or data 820 may be placed within the application code 811. Likewise, embedded keys or code checksums 821, such as the results of a message digest algorithm applied to the applicaiton code or file, may also be embedded within the application code 811. An example of a message digest algorithm is the SHA algorithm. Message digest algorithms are well known to one of ordinary skill in the art, and will not be described in detail herein. In the preferred embodiment, the wrapping tool performs the insertion of protection code, data, and keys within the application code 811 automatically.

The present invention has been described in accordance with the embodiments shown, and one of ordinary skill in the art will readily recognize that there could be variations to the embodiments, and any variations would be within the spirit and scope of the present invention. In addition, software written according to the present invention may be stored on a computer-readable medium, such as a removable memory, or transmitted over a network, and loaded into the server for execution. Accordingly, many modifications may be made by one of ordinary skill in is the art without departing from the spirit and scope of the appended claims.

What is claimed is:

1 A method for providing secure authoring services for protected software to a software publisher, the method comprising the steps of:
(a) creating a protection authoring toolset on a networked server;
(b) receiving from the publisher over the network a copy of the software product to be protected;
(c) processing on the server the software product by the protection authoring toolset, wherein the software product is wrapped in a protection software wrapper; and
(d) returning the protected software product to the publisher over the network for delivery to customers.

2 The method of claim 1 further including the step of setting up an account for the publisher on the networked server.

3 The method of claim 2 further including the step of verifying the identity of the publisher before setting up the account on the server.

4 The method of claim 1 wherein step (b) further includes the step of receiving options and settings from the publisher wherein the options and settings modify the function of the protection wrapper.

5 The method of claim 4 further including the step of testing the settings and options on the server by using a protection wrapper simulator to simulate a resulting user interface generated by the protection wrapper without having to download the protected application to the publisher.

6 The method of claim 1 further including the step of creating a license authorization on the server for transfer by the protection wrapper software to a removable security device connected to the computer running the licensed software.

7 The method of claim 2 further including the step of providing a user management tool with the publisher's account, wherein the publisher can set different levels of access to the account for different users in the publisher's organization.

8 The method of claim 4 further including the steps of assigning a unique code to each version of the protected software, providing the unique code to the publisher along with the protected software, and saving a copy of the protected software along with the state of the options and settings in a database, wherein the publisher can provide the unique code in a trouble report, thus allowing the tool provider the ability to quickly access the settings and options used by the publisher, along with the resulting protected software, for testing and determining the cause of the reported trouble.

9 The method of claim 1 further including the step of providing a secure reporting function for the server to transmit a log of activity to the tool provider on request from the tool provider.

10 The method of claim 9 further including the step of providing a secure management function for the server wherein the server activity can be restricted and controlled remotely by the tool provider.

11 The method of claim 1 further including the step of providing all access to the server toolset with a standard web browser.

12 The method of claim 11 further including the step of providing a helper application to work in conjunction with the web browser to provide the ability to modify or reset the license state on the publisher's computer.

13 The method of claim 1 further including the step of providing a remote secure function server whereby wrapping functions are only provided on the remote secure server via restricted function calls, thus reducing the security requirements of the application server.

14 The method of claim 1 further including the step of providing a billing system on the server wherein each use of the wrapping tool is billed as a separate fee.

15 The method of claim 1 further including the step of providing a billing system on the server wherein each user and account is billed a specific fee based on the type of access and service provided.

16 A method for providing secure authoring and licensing services for protected software to a software publisher, the method comprising the steps of:
(a) creating an protection authoring and licensing toolset on a networked application server;
(b) setting up an account for a software publisher on the application server, including the creation of a publisher public/private key pair and publisher certificate, wherein the publisher private key and publisher certificate are used to create a license for the software product;
(c) receiving options and settings from the publisher for authoring a protected software product associated with the publisher's account;
(d) creating a product public/private key pair and product certificate associated with the software product to be protected, wherein the product private key and product certificate are used to create a license request for the software product;
(e) receiving from the publisher over the network a copy of the software product to be protected;
(f) processing on the server the software product by the protection authoring toolset according to the options and settings, wherein the software product is wrapped in a protection software wrapper including an authorization program that uses the product private key to generate the license request and that validates the license using the publisher certificate;
(g) returning the protected software product to the publisher over the network for testing and delivery to customers, wherein each copy of the delivered software must be licensed for use; and
(h) creating the license for the protected software product on the application server in response to a license request being received from the protected software, using the publisher private key and certificate and the product private key and certificate.

17 The method of claim 16 further including the step of verifying the identity of the publisher before setting up the account on the server.

18 The method of claim 16 further including the step of testing the settings and options on the server by using a protection wrapper simulator to simulate a resulting user interface generated by the protection wrapper without having to download the protected application to the publisher.

19 The method of claim 16 further including the step of creating a license authorization on the server for transfer by the protection wrapper software to a removable security device connected to the computer running the licensed software.

20 The method of claim 16 further including the step of providing a user management tool with the publisher's account, wherein the publisher can set different levels of access to the account for different users in the publisher's organization.

21 The method of claim 16 further including the step of assigning a unique code to each version of the protected software, providing the unique code to the publisher along with the protected software, and saving a copy of the protected software along with the state of the options and settings in a database, wherein the publisher can provide the unique code in a trouble report, thus allowing the tool provider the ability to quickly access the settings and options used by the publisher, along with the resulting protected software, for testing and determining the cause of the reported trouble.

22 The method of claim 16 further including the step of providing a secure reporting function for the server to transmit a log of activity to the tool provider on request from the tool provider.

23 The method of claim 22 further including the step of providing a secure management function for the server wherein the server activity can be restricted and controlled remotely by the tool provider.

24 The method of claim 16 further including the step of providing all access to the server toolset with a standard web browser.

25 The method of claim 24 further including the step of providing a helper application to work in conjunction with the web browser to provide the ability to modify or reset the license state on the publisher's computer.

26 The method of claim 16 further including the step of providing an external security device for the server to store publisher and product private keys, accessible only by encryption/decryption commands, wherein the private keys are not accessible over the network to hackers.

27 The method of claim 16 further including the step of providing a remote secure function server whereby wrapping functions are only provided on the remote secure server via restricted function calls, thus reducing the security requirements of the application server.

28 The method of claim 16 further including the step of providing a billing system on the server wherein each use of the wrapping tool is billed as a separate fee.

29 The method of claim 16 further including the step of providing a billing system on the server wherein each user and account is billed a specific fee based on the type of access and service provided.
